(19) United States
(12) Patent Application Publication
(10) Pub. No.: US 2020/0267935 A1
(43) Pub. Date: Aug. 27, 2020

(54) Pet Toy

(71) Applicant: Bencoo, Inc dba Zippy Paws, Chino, CA (US)

(72) Inventor: Jennifer Glaser, Pasadena, CA (US)

(21) Appl. No.: 16/794,524

(22) Filed: Feb. 19, 2020

Related U.S. Application Data
(60) Provisional application No. 62/809,484, filed on Feb. 22, 2019.

(51) Int. Cl. A01K 15/02; A63H 5/00

(52) U.S. Cl. CPC A01K 15/025; A63H 5/00

(57) ABSTRACT

The present application discloses a pet toy including a body and a sound generator. The sound generator is disposed within the body. The sound generator is capable of generating sound when rolling the body. The body comprises at least one body hole and the sound generator comprises an outer tube; a sleeve slidably disposed within the outer tube; an inner tube disposed within the sleeve; and a sound generator disposed within the inner tube. The sound maker comprises a toning wedge and a reed vibrating toward the toning wedge. The sound maker may further comprise an o-ring bundling the toning wedge and the reed. In various exemplary embodiments, the toning wedge is curved.

### CROSS-REFERENCE TO RELATED APPLICATION

This application claims the priority of provisional patent application U.S. Ser. No. 62/809,484 filed Feb. 22, 2019 which is expressly incorporated by reference herein in its entirety.

### TECHNICAL FIELD OF THE INVENTION

The present application generally relates to pet toys, and more particularly, to a pet toy with a sound generator.

### BACKGROUND OF THE INVENTION

Generally, an electronic device is built in the pet toy for sound-making. However, it is required for the user to replace the battery frequently. In addition, the leakage of battery may bring contamination and it is also dangerous for the pet. Furthermore, the cost is high since the electronic structure is complicated and easily to be broken.

Therefore, a need remains for a pet toy to generate sound via an easier and cheaper way.

### SUMMARY OF THE INVENTION

The present application discloses a pet toy to generate sound via an easier and cheaper way.

The pet toy of the present, application comprises a body and a sound generator. The sound generator is disposed within the body. The sound generator is capable of generating sound when rolling the body.

According to an exemplary embodiment of the pet toy, the body comprises a first case and a second case coupled to the first case. The first case comprises at least one protrude and the second case comprises at least one groove. The first case is coupled with the second case via coupling the at least one protrude within the at least one groove. Specifically, the at least one protrude is an annular protrude and the at least one grove is an annular groove.

According to the other exemplary embodiment, the body comprises a first case and a second case coupled to the first case. The first case comprises a first fixture and the second case comprises a second fixture. The sound generator is disposed within the body via the first fixture and the second fixture. Specifically, the first fixture and/or the second fixture is a hollow cylinder. In addition, the first fixture and the first case are molded integrally; and the second fixture and the second case are molded integrally.

In various exemplary embodiments, the body comprises at least one body hole, and the sound generator comprises an outer tube; a sleeve slidably disposed within the outer tube; an inner tube disposed within the sleeve; and a sound maker disposed within the inner tube.

In various exemplary embodiments, the sound maker comprises a toning wedge and a reed vibrating toward the toning wedge. The sound maker may further comprise an o-ring bundling the toning wedge and the reed. In various exemplary embodiments, the toning wedge is curved.

According to an exemplary embodiment of the pet toy, the sound generator further comprises an inner cap coupled to the inner tube. The inner cap comprises at least one inner cap hole. Specifically, the inner cap comprises four inner cap holes.

According to the other exemplary embodiment, the sound generator further comprises an outer cap coupled to the outer tube. The outer cap comprises at least one, outer cap hole. Specifically, the outer cap comprises two outer cap holes.

In various exemplary embodiments, the body comprises one body hole.

Based on, the above, the present application allows the pets to generate sound simply by rolling the body, reducing the trouble of utilizing the battery. In addition, the weight and the cost may also be decreased significantly since the electronic device is not required according to the present application.

Numerous other advantages and features of the present application will become readily apparent from the following, detailed description of disclosed embodiments, from the claims and from the accompanying drawings.

### BRIEF DESCRIPTION OF THE DRAWINGS

The objects, features and advantages of the present application will be more readily appreciated upon reference to the following disclosure when considered in conjunction with the accompanying drawings, wherein like reference numerals are used to identify identical components in the various views, and wherein reference numerals with alphabetic characters are utilized to identify additional types, instantiations or variations of a selected component embodiment in the various views, in which:

FIG. 1 is a perspective view of a pet, toy of the present application.

FIG. 2 is an explosive view of the pet toy of the present application.

FIGS. 3A-3B are cross-sectional views through an A-A′ plane of the pet toy of FIG. 1, showing the mechanism of generating sound.

### DETAILED DESCRIPTION OF DISCLOSED EMBODIMENTS

Reference will now be made in detail to the present representative embodiments of the present application, examples of which are illustrated in the accompanying drawings. Wherever possible, the same reference numbers are used in the drawings and the description to refer to the same or like parts.

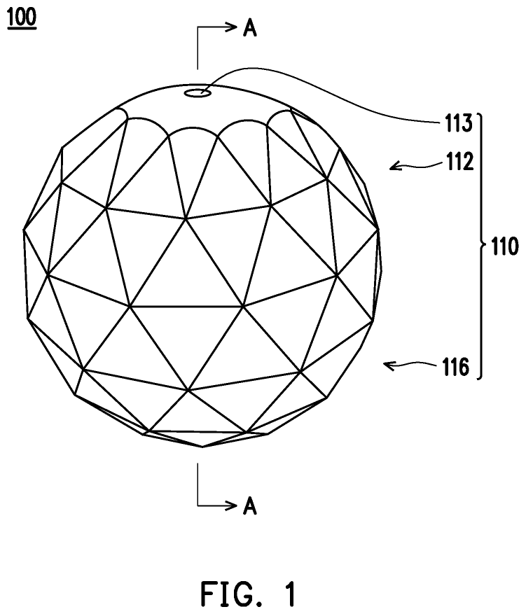

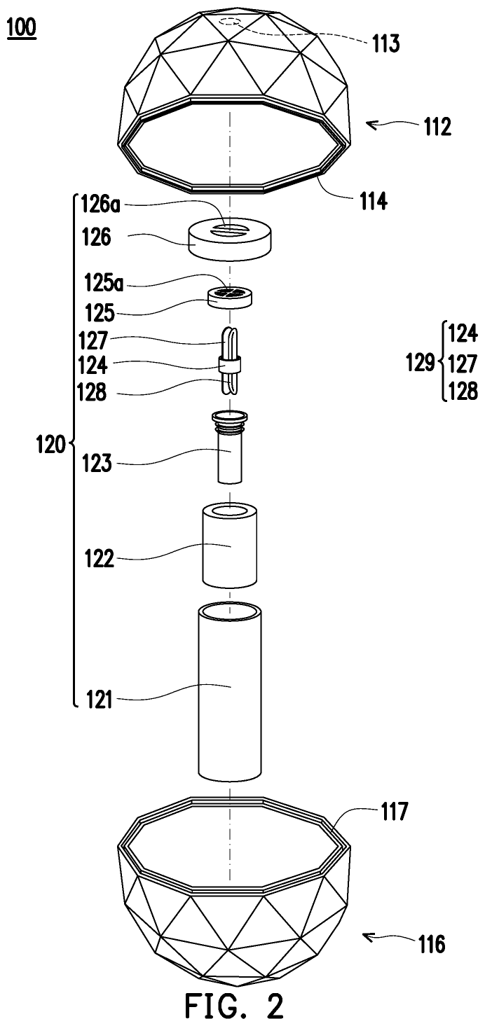

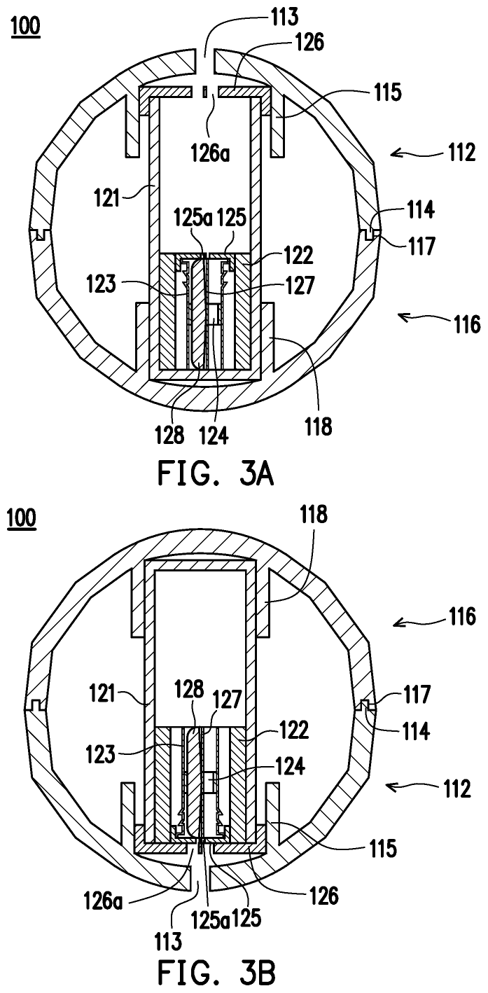

FIG. 1 is, a perspective view of a pet toy 100 of the present application. FIG. 2 is an explosive view of the pet toy 100 of the present application. FIG. 3A is a cross-sectional view through an A-A′ plane of the pet toy 100 of FIG. 1.

Referring to FIGS. 1-3A, the pet toy 100 of the present application comprises a body 110 and a sound generator 120.

The body 110 comprises a first case 112 and a second case 116. Both of the first case 112 and the second case 116 are polyhedral. Specifically, the combination of the first case 112 and the second case 116 is quasi-spherical. However, the present application is not limited. The combination of the first case 112 and the second case 116 may be other shapes such as cube or pyramid as long as the user can roll or rotate the pet toy 100 after combining the first case 112 and the second case 116. The first case 112 and the second case 116 are made of elastic material such as rubber. As such, it is hard to be broken by animal biting.

The first case 112 comprises a hole 113, a protrude 114 and a first fixture 115. It should be noted that although the first case 112 of the present application only comprises one hole 113, the present application is not limited. The first case 112 may comprise more than one hole 113 as long as an air flow can be generated between outside environment and inside of the combination of the first case 112 and the second case 116. The protrude 114 of the present application is an annular protrude 114. The first fixture 115 is a hollow cylinder and is molded with the first case 112 integrally. However, the present application is not limited thereto. The first fixture 115 may be other shapes as long as the first fixture 115 can hold the sound generator 120 inside the body 110. In addition, the first fixture 115 may be coupled to the first case 112 via adhesive or screw etc.

The second case 116 comprises a groove 117 and a second fixture 118. The groove of the present application is an annular groove 116. The second fixture 118 is a hollow cylinder and is molded with the second case 116 integrally. However, the present application is not limited thereto. The second fixture 118 may be other shapes as long as the second fixture 118 can hold the sound generator 120 inside the body 110. In addition, the second fixture 118 may be coupled to the second case 116 via adhesive or screw etc.

It should be noted that the protrude 114 of the first case 112 and the groove 117 of the second case 116 are not limited in the present application as long as the first case 112 and the second case 116 can be coupled with each other. For example, the protrude may be a plurality of pointed protrusion and the groove may be a plurality of grooves corresponding to the plurality of the pointed protrusion.

Referring to FIGS. 2-3A, the sound generator 120 comprises an outer tube 121, a sleeve 122, an inner tube 123, an inner cap 125, an outer cap 126 and a sound maker 129.

The outer tube 121 is coupled to the second fixture 118. The sleeve 122 is slidably disposed within the outer tube 121. The inner tube 123 is disposed within the sleeve 122. The inner cap 125 is coupled to the inner tube 123 and comprises four inner cap holes 125a. The outer cap 126 is coupled to the outer tube 121 and comprises two outer cap holes 126a. However, the present application is not limited thereto. The inner cap 125 and the outer cap 126 may comprise different amount of holes as long as an air flow can be generated between outside environment and inside of the inner tube 123.

The sound maker 129 is disposed within the inner tube 123. The sound maker 129 comprises am o-ring 124, a reed 127 and a toning wedge 128. The o-ring bundles the reed 127 and the toning wedge 128, avoiding the reed 127 from changing location when vibrating. The reed 127 of the present application is flat and plastic. However, the shape and the material may be modified as long as the reed 127 may be vibrated toward the toning wedge 128 due to air pressure when rolling or rotating the pet toy 100. The toning wedge 128 is curved.

FIGS. 3A-3B are cross-sectional views through an A-A′ plane of the pet toy 100 of FIG. 1, showing the mechanism of generating sound.

Referring to FIGS. 3A-3B, the sleeve 122 may slide within the outer tube 121 when rolling the pet toy 110, generating an air flow inside the outer tube 121 and the inner tube 125. As such, the reed 127 inside the inner tube 125 may be vibrated toward the toning wedge 128 and thus generating the sound due to the change of air volume inside the outer tube 121 and the inner tube 123.

Based on the above, the present application allows the pets to generate sound simply by rolling the body, reducing the trouble of utilizing the battery. In addition, the weight and the cost may also be decreased significantly since the electronic device is not required according to the present application.

It will be apparent to those skilled in the art that various modifications and variations can be made to the structure of the present application without departing from the scope or spirit of the present application. In view of the foregoing, it is intended that the present application cover modifications and variations of this application provided they fall within the scope of the following claims and their equivalents.

What is claimed is:

1. A pet toy, comprising:
a body; and
a sound generator disposed within the body, wherein the sound generator is capable of generating sound when rolling the body.

2. The pet toy as claimed in claim 1, wherein the body comprises a first case and a second case coupled to the first case.

3. The pet toy as claimed in claim 2, wherein the first case comprises at least one protrude and the second case comprises at least one groove, the first case is coupled with the second case via coupling the at least one protrude within the at least one groove.

4. The pet toy as claimed in claim 3, wherein the at least one protrude is an annular protrude and the at least one grove is an annular groove.

5. The pet toy as claimed in claim 2, wherein the first case comprises a first fixture and the second case comprises a second fixture, the sound generator is disposed within the body via the first fixture and the second fixture.

6. The pet toy as claimed in claim 5, wherein the first fixture is a hollow cylinder.

7. The pet toy as claimed in claim 5, wherein the first fixture and the first case are molded integrally.

8. The pet toy as claimed in claim 5, wherein the second fixture is a hollow cylinder.

9. The pet toy as claimed in claim 5, wherein the second fixture and the second case are molded integrally.

10. The pet toy as claimed in claim 1, wherein the body comprises at least one body hole and the sound generator comprises:
an outer tube;
a sleeve slidably disposed within the outer tube;
an inner tube disposed within the sleeve; and
a sound maker disposed within the inner tube.

11. The pet toy as claimed in claim 10, wherein the sound generator further comprises an inner cap coupled to the inner tube.

12. The pet toy as claimed in claim 11, wherein the inner cap comprises at least one inner cap hole.

13. The pet toy as claimed in claim 12, wherein the inner cap comprises four inner cap holes.

14. The pet toy as claimed in claim 10, wherein the sound generator further comprises an outer cap coupled to the outer tube.

15. The pet toy as claimed in claim 14, wherein the outer cap comprises at least one outer cap hole.

16. The pet toy as claimed in claim 15, wherein the outer cap comprises two outer cap holes.

17. The pet toy as claimed in claim 10, wherein the body comprises one body hole.

18. The pet toy as claimed in claim 10, wherein the sound maker comprises a toning wedge and a reed vibrating toward the toning wedge.

19. The pet toy as claimed in claim 18, wherein the sound maker further comprises an o-ring bundling the toning wedge and the reed.

20. The pet toy as claimed in claim 18, wherein the toning wedge is curved.
